(19) United States
(12) Patent Application Publication
(10) Pub. No.: US 2004/0045205 A1
(43) Pub. Date: Mar. 11, 2004

(54) Advertising method for changeable bottle bottled water dispenser

(76) Inventors: James Witham, Rancho Mirage, CA (US); Bradford Corbett JR., Ft. Worth, TX (US)

Correspondence Address: Charles D. Gunter, Jr., Whitaker, Chalk, Swindle & Sawyer, LLP, 3500 City Center Tower II, 301 Commerce Street, Ft. Worth, TX, 76102, US

(21) Appl. No.: 10/241,148

(22) Filed: Sep. 11, 2002

(51) Int. Cl. G09F 3/18

(52) U.S. Cl. 40/642.02

(57) ABSTRACT

A method of providing advertising is shown which utilizes an existing bottled water distribution system. A printed message may be applied directly to an exterior surface of selected bottles or a substrate bearing the advertising indicia may be affixed to an exterior surface of selected bottles being cycled within the distribution system. The bottles are delivered to a target group of end users. Periodically, the previously delivered bottles are collected for refilling. The previously applied substrate can then be removed and a new substrate can be applied containing the same or a new advertising message. The relabeled bottles are then again delivered to the target group of end users.

### 1. CROSS REFERENCE TO RELATED APPLICATIONS

The present application is related to the co-pending application of James Witham entitled “Advertising Method For Fixed Bottle Bottled Water Dispenser”, Attorney Docket No. 019296.000004, filed concurrently herewith.

### BACKGROUND OF THE INVENTION

2. Field of the Invention

The present invention relates generally to a method of providing advertising utilizing an existing bottled water distribution system.

3. Background of the Invention

In traditional water dispensers, a replaceable bottle is mounted with a neck and spout downwardly extending into an opening in a ledge of a dispensing stand. The bottle is free standing and held in place by gravity. The bottles may be made of glass or may be made of plastic or other synthetic materials.

In use, bottles often become scratched and unsightly in appearance. It is therefore desirable, in some situations, to provide a decorative covering which at least partly covers the exterior bottle surface. Preferably, such a covering would be temporarily affixed to the bottle and therefore removable.

U.S. Pat. No. 4,834,250, to Dumbeck et al. shows a decorative protective hood for a water dispenser. In this case, the protective hood is a woven fabric, preferably of nylon, which is used to drape the water bottle and which also serves the purpose of preventing the accumulation of dirt or other contamination.

U.S. Pat. No. 5,356,046 to Burke shows another cover for a bottled water dispenser. The cover is provided in the shape of a sack which has an opening and a string for closing the opening of the sack against the neck of the water bottle. Again, the purpose of the Burke invention is to isolate the water bottle from the surrounding environment in order to decrease the chance for transmission of disease and prevent the growth of microorganisms within the water.

None of the above references have as an object to provide an advertising method utilizing the existing bottled water distribution system.

### SUMMARY OF THE INVENTION

The method of the present invention provides an advertising technique utilizing a bottled water distribution system in which individual filled water bottles are distributed to end users and empty bottles are collected for refilling and for redistribution. An advertising message is either applied directly to the bottle exterior or is applied to a suitable substrate. Where the message is applied to a substrate, the substrate is preferably either a plain band such as a paper band or a shrink-wrap plastic material. The substrate is then secured to an exterior surface of a selected number of bottles being cycled within the water distribution system. The selected water bottles are delivered to a target group of end users. Preferably, the target group is selected based upon specific market analysis criteria. Periodically, the previously delivered bottles are collected for refilling. The previously applied substrate which contains the previously applied advertising message can then be removed, if desired. A new substrate can then be applied containing a new advertising message to the previously connected bottles to thereby relabel the bottles. The relabeled bottles can then be delivered to the target group of end users.

Additional objects, features and advantages will be apparent in the written description which follows.

### BRIEF DESCRIPTION OF THE DRAWINGS

FIG. 1 shows a bottled water apparatus including a water bottle labeled according to the method of the invention, the bottle being supported upon a dispensing stand;

FIG. 2 is a schematic illustration of one step in the method of the invention in which an advertising message is applied to a substrate; and

FIG. 3 is also a schematic diagram representative of the subsequent step in the method of the invention in which the substrate is a heat shrink material which is affixed to an exterior surface of the water bottle.

### DETAILED DESCRIPTION OF THE INVENTION

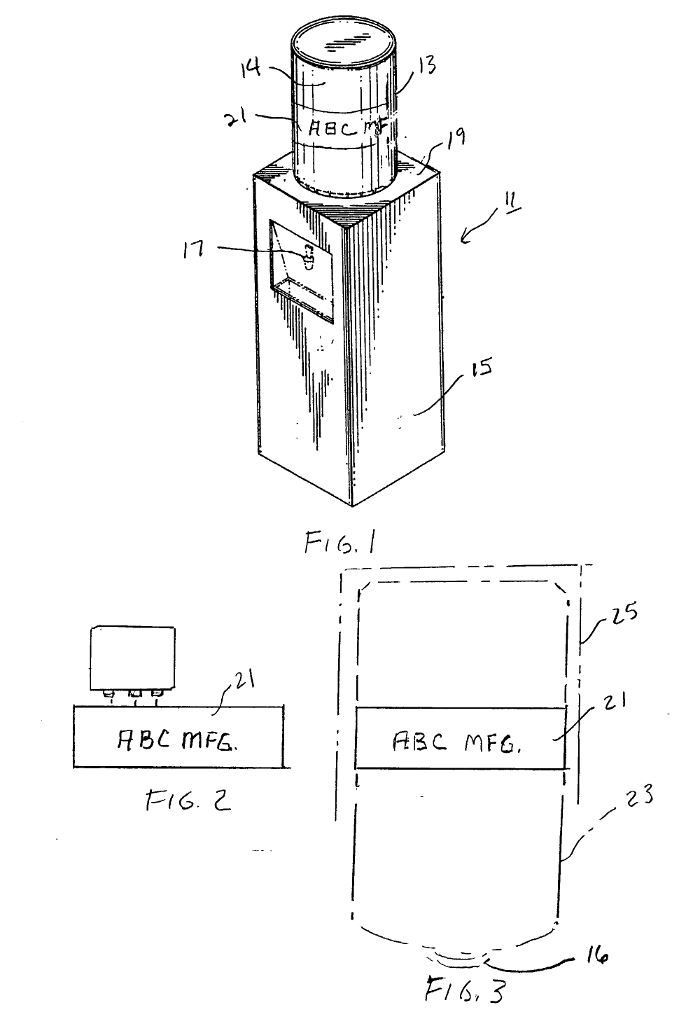

FIG. 1 shows a conventional bottled water dispensing apparatus designated generally as 11. The apparatus 11 includes a bottle 13 and a dispensing stand 15. The particular bottle illustrated has a cylindrical exterior surface 14 and a neck portion (16 in FIG. 3) which forms an outlet spout extending from one end of the bottle. Typical bottle capacities are 3, 5 and 6 gallons, respectively. Other bottle dimensions and shapes may be used, however, without departing from the spirit and scope of the invention.

The dispensing stand 15 typically contains cooling and heating elements for dispensing water from the bottle 13 through the respective discharge faucet or faucets 17. The water bottle 13 is itself typically maintained at ambient temperature.

The dispensing stand 15 has a top ledge 19 with an opening (not shown) for receiving the neck 16 of the bottle 13 for stably supporting the bottle by reason of gravity. The bottle 13 is received in the position shown in FIG. 1 until its water contents are dispensed and a newly filled substitute bottle is replaced in the opening provided on the ledge 19.

FIGS. 2 and 3 are schematic representations of the steps involved in practicing the method of the invention. The first step of the method involves the application of an advertising message, such as the label “ABC MFG” either directly to the bottle exterior surface 14 or to a suitable substrate. The substrate could be a plain paper band which would be placed around the exterior of the bottle and adhered in any convenient manner, such as by the use of a suitable adhesive, or even by frictional engagement. In the embodiment of FIGS. 2 and 3, the substrate comprises a shrink-wrap plastic material such as polyethylene. In the method illustrated in FIG. 2, the advertising message is applied to the substrate through the use of an ink jet printer. Ink jet printers apply a wide range of ink compositions to selected target surfaces as discreet droplets of ink which form an image on the surface. The droplets can be applied using drop on demand or impulse jet printers in which individual droplets are ejected from individual nozzle orifices in an array of nozzles, the position of the printed droplet on the surface being dictated by the nozzle in the array from which it is ejected. Alternatively, the ink jet printer can be a continuous jet printer in which droplets are formed from a jet of ink issuing from a single nozzle, the droplets being given an electric charge and passing through a deflection field which deflects the flight of the individual droplets away from the straight line path by an amount depending upon the strength of the charge and/or the deflecting field. For convenience herein, the term “ink jet printer” will be used to denote all such types of printers. While ink jet printers offer a convenient method for applying the advertising message to the substrate, it will be understood that other conventional printing methods may be utilized, as well.

In the next step in the method, the shrink wrap plastic material (21 in FIG. 2) is then secured to an exterior surface 23 of a selected number of bottles 13 which are being cycled within a bottled water distribution system.

The shrink-wrap material 21 can be applied to the bottle exterior in any of a number of conventional ways. In a typical in-line shrink wrap packaging procedure, one or more unpackaged items are moved towards a shrink wrap cutting and sealing area by an end-feed conveyor. As the items are moved into the shrink wrap cutting and sealing area, the items are surrounded by center-folded shrink wrap film that has been partly unfolded so that the items can be conveyed into to the partially unfolded center-folded film. When the items have been conveyed into the partially unfolded center-folded film, the items exit the end-feed conveyor and are transferred to an exit conveyor. Typically, the exit conveyer continues conveying the items until the items are moved to the shrink-wrap cutting and sealing area beyond a designated cross-sealing location. At that point, it is typical to stop forward movement of the exit conveyor and use a hot knife system to cut the layers of shrink wrap film and contemporaneously weld or seal the layers of film together at the cut so that the shrink wrap film is wrapped around the item.

After the shrink-wrap film has been cut and sealed, the exit conveyor is again activated. The items are then moved into a shrink tunnel or oven illustrated schematically as 25 in FIG. 3. After each group of items is heated in the shrink tunnel, the shrink-wrap tightens around the item so that the item is securely wrapped.

The cutting and sealing is repeated on a consecutive group of bottles as the bottles are conveyed through the system.

After a selected number of bottles have been labeled with the shrink-wrap substrate, the bottles are delivered to target group of end users. Preferably, the target group is selected based upon specific market analysis criteria. Thus, the advertising message would be a message specifically appealing to members of the target group. In addition to bearing advertising indicia, the label 21 could contain artwork or other types of esthetically pleasing materials which would not only serve the purpose of advertising but also improve the esthetic appearance of the water bottle itself.

Also, while the substrate material has been described with reference to conventional polyethylene, other materials might be heat shrunk as well. For example, a suitable insulating type wrapper might be utilized. U.S. Pat. No. 4,626,455, to Karabedian, for example, describes a tough, heat shrunk sleeve which can be used to cover a drink bottle. The material utilized is a co extruded multilayer sheet which includes an insulating polystyrene foam layer for the inside of the sleeve next to the bottle. This type material, or other suitable insulating materials, could therefore be utilized in place of the polyethylene substrate described above. In addition to providing an insulating barrier, the label 21 could also structurally reinforce the bottle and help to shield it from scratches or punctures.

In the subsequent steps of the method of the invention, the previously delivered bottles 13 are periodically collected for refilling. The previously applied substrate can then be easily removed. The identical substrate or a new substrate containing a new advertising message can then be applied to the previously collected bottles to thereby relabel the bottles. In the case in which the advertising message is printed directly onto the bottle exterior surface, a replacement bottle with a different message could be supplied, as well. In the final step of the method, the relabeled bottles are delivered to the target group of end users.

An invention has been provided with several advantages. The advertising method of the invention utilizes an existing bottled water distribution system and provides a convenient advertising medium at little additional cost. The labeling technique not only provides for the transmission of and advertising message to a target group of end users but can also provide a means for improving the esthetic appearance of the water bottle itself. Additionally, by choosing an appropriate labeling substrate, other desirable qualities such as an insulating or reinforcing effect can be provided. The technique is simple to implement and can easily be carried out in a reliable manufacturing process.

While the invention has been shown in only one its forms, it is not thus limited but is susceptible to various changes and modifications without departing from the spirit thereof.

What is claimed is:

1. A method of providing advertising utilizing a bottled water distribution system, in which individual filled water bottles are distributed to end users and empty bottles are collected for refilling and for redistribution, the method comprising the steps of:
applying an advertising message to an exterior surface of a selected number of bottles;
delivering the selected bottles to a target group of end users, the target group being selected based upon specific market analysis criteria.

2. A method of providing advertising utilizing a bottled water distribution system, in which individual filled water bottles are distributed to end users and empty bottles are collected for refilling and for redistribution, the method comprising the steps of:
applying an advertising message to a substrate;
securing the substrate to an exterior surface of a selected number of bottles being cycled within the water distribution system; and
delivering the selected bottles to a target group of end users, the target group being selected based upon specific market analysis criteria.

3. The method of claim 2, wherein the substrate comprises a shrink-wrap plastic material.

4. The method of claim 2, wherein the substrate comprises an insulating material.

5. The method of claim 2, wherein the substrate forms a structural reinforcement for the water bottle.

6. The method of claim 2, wherein the advertising message is applied to the substrate in a large character ink jet printing process.

7. The method of providing advertising utilizing a bottled water distribution system, in which individual filled water bottles are distributed to end users and empty bottles are collected for refilling and for redistribution, the method comprising the steps of:
applying an advertising message to a substrate;
securing the substrate to an exterior surface of a selected number of bottles being cycled within the water distribution system;
delivering the selected bottles to a target group of end users, the target group being selected based upon specific market analysis criteria;
periodically collecting the previously delivered bottles for refilling;
removing the previously applied substrate containing the previously applied advertising message;
applying a new substrate containing a new advertising message to the previously collected bottles to thereby relabel the bottles;
delivering the relabeled bottled to the target group of end users.

8. The method of claim 7 wherein the substrate comprises a shrink-wrap plastic material.

9. The method of claim 7 wherein the substrate comprises an insulating material.

10. The method of claim 7 wherein the substrate forms a structural reinforcement for the water bottle.

11. The method of claim 7 wherein the advertising message is applied to the substrate in a large character ink jet printing process.
